(19) United States
(12) Patent Application Publication
(10) Pub. No.: US 2026/0260301 A1
(43) Pub. Date: Sep. 3, 2026

(54) SYSTEM AND METHOD FOR A BLOCKCHAIN BASED PLATFORM WITH LONG RANGE P2P ENERGY TRANSFER

(71) Applicant: JIO PLATFORMS LIMITED, Ahmedabad (IN)

(72) Inventors: Dilip KRISHNASWAMY, Bangalore (IN); Dipender BHAMRAH, Noida (IN)

(73) Assignee: JIO PLATFORMS LIMITED, Ahmedabad (IN)

(21) Appl. No.: 18/714,000

(22) PCT Filed: Nov. 28, 2022
(86) PCT No.: PCT/IB2022/061472

§ 371 Date: May 28, 2024

(30) Foreign Application Priority Data
Nov. 29, 2021 (IN) 202121055067

(51) Int. Cl. G06Q 50/06; H04L 9/00; H04L 9/32

(52) U.S. Cl. CPC G06Q 50/06; H04L 9/3247; H04L 9/50; G06Q 2220/00

(57) ABSTRACT

Present disclosure generally relates to energy resource networks, more particularly relates to methods and systems for transferring long range peer-peer (P2P) energy. The blockchain based platform/system connects the entities and the consumers. The system may process a digital contract between the entities such as the renewable energy producer, utility grids and the consumers such as enterprise energy consumer or smart energy community consumer. The system may facilitate physical energy transfer from the entities to the consumers through utility grid facilities. The system provides support for fault tolerance utilizing multiple energy sources, and stores excess energy to be utilized at a time when needed. The execution of digital contract triggers physical transfer of energy from the entities to the consumers including the intermediate entities.

### RESERVATION OF RIGHTS

A portion of the disclosure of this patent document contains material, which is subject to intellectual property rights such as, but are not limited to, copyright, design, trademark, IC layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to energy distribution networks. More particularly, the present disclosure provides a system and method for a blockchain based platform with long range peer to peer (P2P) energy transfer.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, energy produced by large renewable energy farms (solar/wind) can be physically transferred to enterprises or smart communities for consumption. Multiple utility grids may be involved in such physical transfer of energy using Alternating Current (AC) or High-Voltage Direct Current (HVDC) lines for long distance transfers. Further, dynamic digital contracts may be required between a renewable energy producer (solar/wind farms) and a consumer (such as an enterprise or a smart community), to enable the physical transfer of energy. Also, the energy transfer may include the source, destination grids, and intermediate entities in the energy transfer.

However, limited information is available to electric power consumers about the types of power supply as electric power supply data, power consumption data, market data, capacity, and transmission rights are not provided to consumers/end users. Furthermore, the existing systems and methods do not have access to data and analytics to provide optimal pricing for power supplied to business and/or residential electricity customers. Additionally, existing systems and methods do not have the ability to provide advanced energy settlements that may be economically priced. Also, existing system and methods may be unable to meet the continuous power supply/energy demand requested at predetermined times due to the reduced power production.

There is therefore a need in the art for a system and method for a blockchain based platform with long range peer to peer energy transfer that can overcome the aforementioned problems in the art.

### OBJECTS OF THE PRESENT DISCLOSURE

Some of the objects of the present disclosure, which at least one embodiment herein satisfies are as listed herein below.

It is an object of the present disclosure to provide a system and a method to facilitate the long range peer to peer energy transfer.

It is an object of the present disclosure to provide a blockchain based platform/system to enable the distribution of energy from entities to consumers.

It is an object of the present disclosure to provide a block chain based platform/system that enables negotiation between the entities and the consumers.

It is an object of the present disclosure to provide a blockchain based platform that executes the smart contract to determine cost incurred by the consumers and revenue accumulated by the entities.

It is an object of the present disclosure to provide a block chain based platform that enables multiple energy sources to supply energy to the consumers to ensure fault tolerance in the long range peer to peer energy transfer.

### SUMMARY

This section is provided to introduce certain objects and aspects of the present disclosure in a simplified form that are further described below in the detailed description. This summary is not intended to identify the key features or the scope of the claimed subject matter.

In an aspect, the blockchain based platform/system may include a plurality of nodes communicatively coupled to each other. Each of the nodes may be configured with one or more processors, where the one or more processors may be further coupled with a memory with instructions to be executed by the one or more processors. The blockchain based platform/system may receive one or more requests from one or more first computing devices indicative of an energy demand. The one or more first computing devices may be associated with one or more consumers and communicatively coupled to the blockchain network through a communication network. The system may also receive one or more inputs from one or more second computing devices indicative of an energy supply. The one or more second computing devices may be associated with one or more entities and communicatively coupled to the blockchain network through the communication network. The system may extract a first set of attributes from the one or more requests indicative of the energy demand from the one or more consumers. The system may also extract a second set of attributes based on the first set of attributes, where the second set of attributes indicative of the energy supply from the one or more entities. The system based on the first set of attributes, and the second set of attributes, may form a digital contract between the one or more entities and the one or more consumers. The digital contract may be indicative of the cost of a unit of energy associated with an energy transfer across one or more time windows from the one or more entities to the one or more consumers. Based on the digital contract, the system may initiate the energy transfer from the one or more entities to the one or more consumers.

In an embodiment, the blockchain based platform/system may be configured to record a negotiation between the one or more entities and the one or more consumers based on the digital contract. The negotiation may be indicative of the total units of energy transfer associated with the unit of energy across the one or more time windows.

In an embodiment, the blockchain based platform/system may be configured with a ledger to record the digital contract and the negotiation between the one or more entities and the one or more consumers.

In an embodiment, the blockchain based platform/system may be configured to verify the digital contract, using one or more digital signatures from the one or more entities and the one or more consumers, and initiate the energy transfer.

In an embodiment, the blockchain based platform/system may be configured to record the negotiation, and the verified digital contract in a ledger to be accessed for verification of the one or more digital signatures.

In an embodiment, the blockchain based platform/system may be configured to include any or a combination, but not limited to a renewable energy producer, a source utility smart grid and a destination utility smart grid as the one or more entities.

In an embodiment, the blockchain based platform/system may be configured to record one or more parameters such as an energy transfer cost, an energy transfer duration, and the total units of energy transfer associated with energy transfer from the one or more entities to the one or more consumers.

In an embodiment, the blockchain based platform/system may be configured to compute an energy loss based on the total units of energy transfer across the one or more windows and record the differential energy transfer from the one or more entities to the one or more consumers.

In an embodiment, the blockchain based platform/system may be configured to enable a dynamic energy transfer based on the recorded differential energy transfer from the one or more entities to the one or more consumers.

In an embodiment, the blockchain based platform/system may be configured to compute the revenue accumulated by the one or more entities based on the energy transfer from the one or more entities to the one or more consumers.

In an embodiment, the blockchain based platform/system may be configured to use one or more additional platforms to settle the revenue accumulated by the one or more entities and the cost incurred by the one or more sources based on the dynamic energy transfer.

In an embodiment, the blockchain based platform/system may be configured to use a plurality of energy sources with any or a combination, but not limited solar energy and wind energy to provide a multi-path fault tolerant energy transfer. The multi-path fault tolerant energy transfer may be indicative of the dynamic energy transfer across the one or more time windows from the one or more entities to the one or more consumers.

In an embodiment, the blockchain based platform/system may be configured to compute a smart contract based on the multi-path fault tolerant energy transfer. The smart contract may be indicative of the dynamic energy transfer from the plurality of energy sources across the one or more time windows from the one or more entities to the one or more consumers.

In an embodiment, the blockchain based platform/system may be configured to record the revenue accumulated by the one or more entities and the cost incurred by the one or more sources based on the smart contract.

In an embodiment, the blockchain based platform/system may be configured to compute an excess energy supply from the plurality of energy sources and record the excess energy supply in the ledger. The system may enable the one or more consumers to select from the plurality of energy sources to receive the dynamic energy transfer across the one or more time windows.

In an aspect, a method for the blockchain based platform/system may include a blockchain network comprising a plurality of nodes communicatively coupled to each other. Each of the nodes may be configured with one or more processors coupled with a memory that stores instructions to be executed by the one or more processors. The system may include receiving, by the processor, one or more requests from one or more first computing devices indicative of an energy demand. The one or more first computing devices may be associated with one or more consumers and communicatively coupled to the blockchain network through a communication network. The system may include receiving, by the processor, one or more inputs from one or more second computing devices indicative of an energy supply. The one or more second computing devices may be associated with one or more entities and communicatively coupled to the blockchain network through the communication network. The system may include extracting, by the processor, a first set of attributes from the one or more requests indicative of the energy demand from the one or more consumers. The system may include extracting, by the processor, a second set of attributes based on the first set of attributes, where the second set of attributes indicative of the energy supply from the one or more entities. The system may include forming, by the processor, based on the first set of attributes, and the second set of attributes, a digital contract between the one or more entities and the one or more consumers. The digital contract may be indicative of a cost of a unit of an energy transfer across one or more time windows from the one or more entities to the one or more consumers. Further, the system may include initiating, by the processor, based on the digital contract, the energy transfer from the one or more entities to the one or more consumers.

In an embodiment, the method for the blockchain based platform/system may further include recording, by the processor, a negotiation between the one or more entities and the one or more consumers based on the digital contract. The negotiation may be indicative of the total units of energy transfer associated with a unit of energy transfer across the one or more time windows.

In an embodiment, the method for the blockchain based platform/system may further include verifying, by the processor, the digital contract, using one or more digital signatures from the one or more entities and the one or more consumers, and initiate the energy transfer. The method may also include initiating the energy transfer from the one or more entities to the one or more consumers.

In an embodiment, the method for the blockchain based platform/system may include recording by the processor, the negotiation, and the verified digital contract in a ledger.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture (100) of the proposed blockchain based platform/system (110), in accordance with an embodiment of the present disclosure.

FIG. 2 illustrates an exemplary block diagram (200) representation of proposed blockchain based platform/system (110) for providing long range peer-to-peer (P2P) energy transfer, in accordance with an embodiment of the present disclosure.

FIG. 3A illustrates exemplary flow diagram (300) representation of the blockchain based platform/system (110) for long range P2P energy transfer, in accordance with an embodiment of the present disclosure.

FIG. 3B illustrates an exemplary schematic diagram (350) representation of the energy transfer from a single source (S1) to a destination (D), in accordance with an embodiment of the present disclosure.

FIG. 3C illustrates an exemplary schematic diagram (380) representation of the multi-source fault tolerant long range P2P energy transfer, in accordance with an embodiment of the present disclosure.

FIG. 4 illustrates a sequence diagram representation of the long-range peer to peer energy exchange platform (P2P) (400), in accordance with an embodiment of the present disclosure.

FIG. 5 illustrates an exemplary computer system (500), in accordance with embodiments of the present disclosure.

### BRIEF DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present disclosure provide methods and systems for transferring long range peer-peer (P2P) energy between the renewable energy producer and the enterprise energy consumer. In an embodiment, the blockchain based platform/system (also referred as the long range peer to peer energy transfer platform) includes a block chain based platform for transferring long range peer-peer (P2P) energy transfer between the renewable energy producer and the enterprise energy consumer with digital signature verification. Specifically, the system includes the blockchain-based long range P2P energy transfer platform (LoRPET) that enables energy transfer between the renewable energy producer and the enterprise energy consumer. Further, the blockchain based platform/system provides options for negotiation between the renewable energy producer and the enterprise energy consumer for energy distribution and consumption. Additionally, the system enables storage of excess energy at the source utility smart grid or at the destination utility smart grid to be used at a later time when energy depletes either at the source or the destination. The present disclosure provides the blockchain/virtualization for Distributed Ledger Technology (vDLT) support to execute smart contracts for energy transfer digitally on a shared distributed ledger across participating entities (includes the renewable energy producer and the enterprise energy consumer), and to enable the physical energy transfer from one or more sources to a destination. The present disclosure provides concurrent support for multiple energy sources to supply energy, and concurrent support for multiple destinations to receive energy.

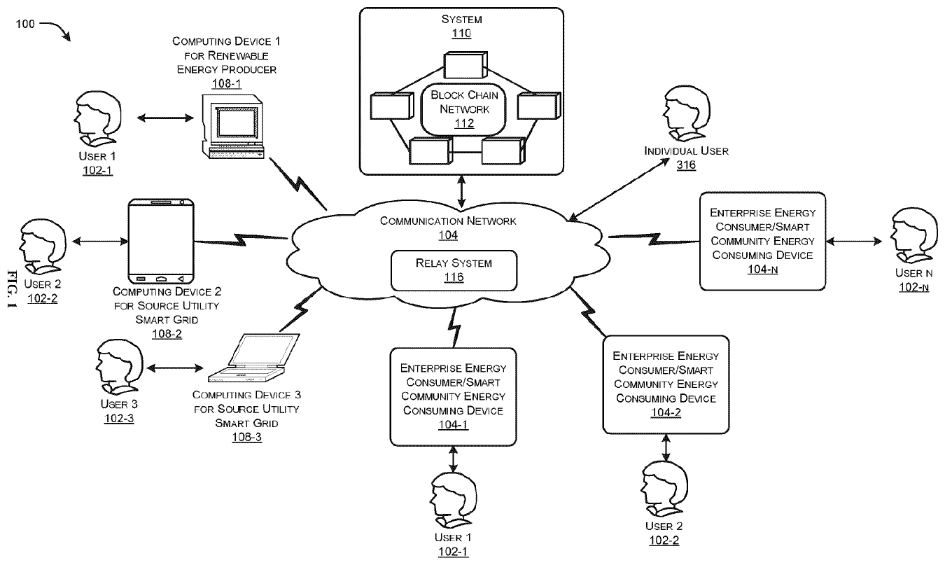

Referring to FIG. 1, an exemplary network architecture for a long-range peer-to-peer energy transfer system (100) (also referred to as network architecture (100)) is provided. As illustrated, the exemplary architecture (100) may be equipped with the system (110) for providing long range peer-to peer energy transfer platform for processing of a digital contract between the energy producing entity/entities (114-1, 114-2, 114-3, . . . , 114-N) (individually referred to as the entity (114) and collectively referred to as the entities (114)). In an embodiment, the entities may include the renewable energy producer, the source utility smart grid and the destination utility smart grid where the entities (or energy producing entities)may be associated with one or more second computing devices (108-1, 108-2, . . . , 108-N) (individually referred to as the second computing device (108) and collectively referred to as the second computing devices (108)). Consumers (102-1, 102-2, 102-3 . . . , 102-N) (individually referred to as the consumer (102) and collectively referred to as the consumers (102)) associated with one or more first computing devices (104-1, 104-2 . . . 104-N). The consumers (102) may include the enterprise energy consumer, the smart community energy consumer, an individual user and the like. The blockchain based platform/system (110) may also be further operatively coupled to the second computing device (108) associated with the entities (114). The entities (114) may include a company, an organisation, a university, a lab facility, a business enterprise, a defence facility, or any other secured facility. For example, the entities (114) may include, but not limited to, a source utility smart grid, a destination utility smart grid, energy regulators, and the like. Further, the blockchain based platform/system (110) may be communicatively coupled to the one or more first computing devices (104)associated with one or more consumers (102). Further, the one or more first computing devices (104) may be communicatively coupled to the blockchain network (112) through the communication network (106). Additionally, the blockchain based platform/system (110) may be communicatively coupled to the one or more second computing devices (108) associated with one or more entities (114). Also, the one or more second computing devices (108) may be communicatively coupled to the blockchain network (112) through the communication network (106).

In an exemplary embodiment, the communication network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, some combination thereof.

The communication network (106) may include transmission line protection systems such transformers, circuit breakers, distance relays, switches and high power transmission lines. Various relay systems (116) may include pilot wire relaying, direct under reaching fault relays, permissive under reaching relays and directional comparison relays. Further, the transmission and distributions lines may include station buses, shunt reactors, series reactors and series capacitors for protection. Two separate relay systems (116) may be incorporated that allows testing of the relays without the removal of the protection lines from service.

In an embodiment, the one or more first computing devices (104), the one or more second computing devices (108) may communicate with the blockchain based platform/system (110) through a set of executable instructions residing on any operating system, including but not limited to, Android™, iOS™, Kai OS™, and the like. In an embodiment, to one or more first computing devices (104), and the one or more second computing devices (108) may include, but not limited to, any electrical, electronic, electro-mechanical or an equipment or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen, receiving devices for receiving any audio or visual signal in any range of frequencies and transmitting devices that can transmit any audio or visual signal in any range of frequencies. It may be appreciated that the one or more first computing devices (104), and the one or more second computing devices (108) may not be restricted to the mentioned devices and various other devices may be used. A smart computing device may be one of the appropriate systems for storing data and other private/sensitive information.

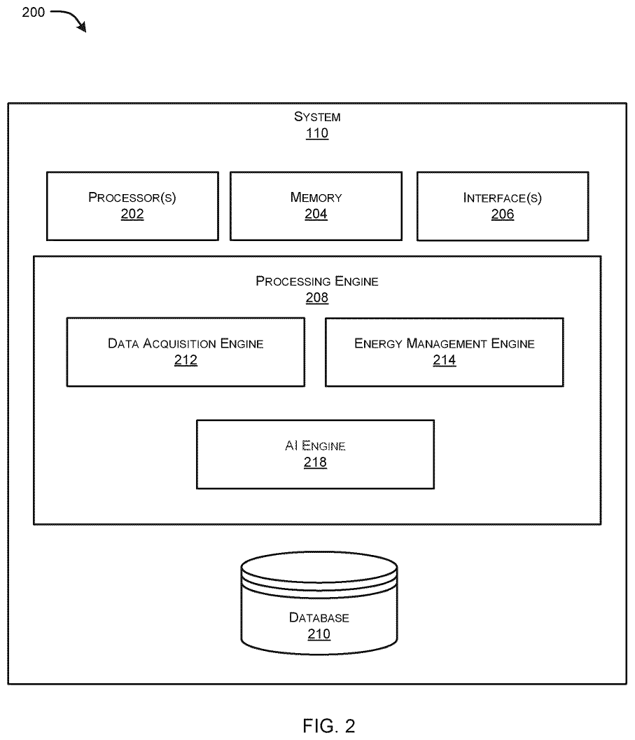

FIG. 2 illustrates an exemplary block diagram representation of proposed blockchain based platform/system (110) for transferring long range peer-peer (P2P) energy transfer, in accordance with an embodiment of the present disclosure. In an aspect, the system (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the blockchain based platform/system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random access memory (RAM), or non-volatile memory such as erasable programmable read only memory (EPROM), flash memory, and the like.

In an embodiment, the blockchain based platform/system (110) may include an interface(s) (206). The interface(s) (206) may comprise a variety of interfaces, for example, interfaces for data input and output devices, referred to as Input/output (I/O) devices, storage devices, and the like. The interface(s) (206) may facilitate communication of the system (110). The interface(s) (206) may also provide a communication pathway for one or more components of the blockchain based platform/system (110). Examples of such components include, but are not limited to, processing unit/engine(s) (208) and a database (210).

The processing unit/engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the blockchain based platform/system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

The processing engine (208) may include one or more engines selected from any of a data acquisition engine (212), an energy management engine (214), and an AI engine (218). In an embodiment, the data acquisition engine (212) may receive the one or more requests from the users (102) pertaining to the energy transfer from the entities (114). The one or more users (102) may operate through the one or more first computing devices (104).

In an embodiment, the data acquisition engine (212) may extract a first set of attributes from the one or more requests by the consumers (102), where the first set of attributes may be indicative of the energy demand from the consumers (102). The data acquisition engine (212) may store the extracted first set of attributes in a database (210). Further, the data acquisition engine (212) may extract a second set of attributes based on the one or more requests. The second set of attributes may be associated with the energy supply from the entities (114) and stored in the database (210). Additionally, the processor (202) may form a digital contract, based on the first set of attributes and the second set of attributes. The digital contract may be indicative of the cost of a unit of energy associated with the energy transfer across one or more time windows from the one or more entities (114) to the one or more consumers (102). The processor (202) based on the digital contract, may initiate the energy transfer from the entities (114) to the consumers (102).

In an embodiment, the blockchain based platform/system (110) may establish a negotiation between the one or more entities (114) and the one or more consumers (102). The data acquisition engine (212) may record a negotiation between the one or more entities (114) and the one or more consumers (102) in the database (210)/ledger based on the digital contract. The negotiation may be indicative of the total units of energy transfer associated with the unit of energy across the one or more time windows.

The energy management engine (214) may verify the digital contract, using one or more digital signatures from the one or more entities (114) and the one or more consumers (102), and initiate the energy transfer. Further, the energy management engine (214) may record the negotiation, and the verified digital contract in the database (210)/ledger.

In an embodiment, the energy management engine (214) may record one or more parameters in the database (210)/ledger. The one or more parameters include the energy transfer cost, the energy transfer duration, and the total units of energy transfer associated with energy transfer from the one or more entities (114) to the one or more consumers (102). Also, the energy management engine (214) may compute an energy loss based on the total units of energy transfer across the one or more windows and record the differential energy transfer in the database (210)/ledger from the one or more entities (114) to the one or more consumers (102). Further, the energy management engine (214) may enable the dynamic energy transfer based on the recorded differential energy transfer from the one or more entities (114) to the one or more consumers (102).

In an embodiment, the energy management engine (214) may compute the revenue accumulated by the one or more entities (114) based on the energy transfer from the one or more entities (114) to the one or more consumers (102). Additionally, the processor (202) may use one or more additional platforms to settle the revenue accumulated by the one or more entities (114) and the cost incurred by the one or more sources (102) based on the dynamic energy transfer.

In an exemplary embodiment, the blockchain based platform/system (110) may include an AI engine (218) that generates an optimized model based on pattern recognition. The AI engine (218) may receive data stored in the database (210) and categorize the data into a predefined data set. The predefined data set may include the energy demand made by the consumers (102), and the energy supply provided by the one or more entities (114). Additionally the AI engine (218) may receive additional data (from the consumers (102) and the entities (114) from the database (210) over a period of time and compute an optimized model for predicting the energy consumption across various months of the year using one or more techniques as known to a person of ordinary skill in the art. The optimized model generated by the AI engine (218) may help the blockchain based platform/system (110) in planning and supplying power from various renewable energy sources and utility grids. For example, the optimized model may predict the power supply requirements throughout the year and specify the amount of power generation to meet the demands of the consumers (102). The AI engine (218) may also calculate the expected usage of energy specific to, but not limited the enterprise energy consumer (308), the smart community energy consumer (310) and the individual user (316).

In an embodiment, the processor (202) may use a plurality of energy sources with any or a combination, but not limited solar energy and wind energy to provide a multi-path fault tolerant energy transfer. Specifically, the multi-path fault tolerant energy transfer may be indicative of the dynamic energy transfer across the one or more time windows from the one or more entities (114) to the one or more consumers (102).

In an embodiment, the energy management engine (214) may compute a smart contract based on the multi-path fault tolerant energy transfer. Specifically, the smart contract may be indicative of the dynamic energy transfer from the plurality of energy sources across the one or more time windows from the one or more entities (114) to the one or more consumers (102). Also, the energy management engine (214) may record the revenue accumulated by the one or more entities (114) and the cost incurred by the one or more sources (102) based on the smart contract in the database (210)/ledger.

In an embodiment, the energy management engine (214) may compute an excess energy supply from the plurality of energy sources and record the excess energy supply in the database (210)/ledger. Additionally, the energy management engine (214) may enable the one or more consumers (102) to select from the plurality of energy sources to receive the dynamic energy transfer across the one or more time windows.

In an embodiment, the ledger may record the energy demand from the consumers (102) and the energy supply from the entities (114). Additionally may include the negotiation provided by the blockchain based platform/system (110) between the entities (114) and the consumers (102). Further, the ledger may also include the revenue accumulated by the entities (114) and the cost incurred by the consumers (102). Also, the ledger may record the excess energy supply from the plurality of energy sources.

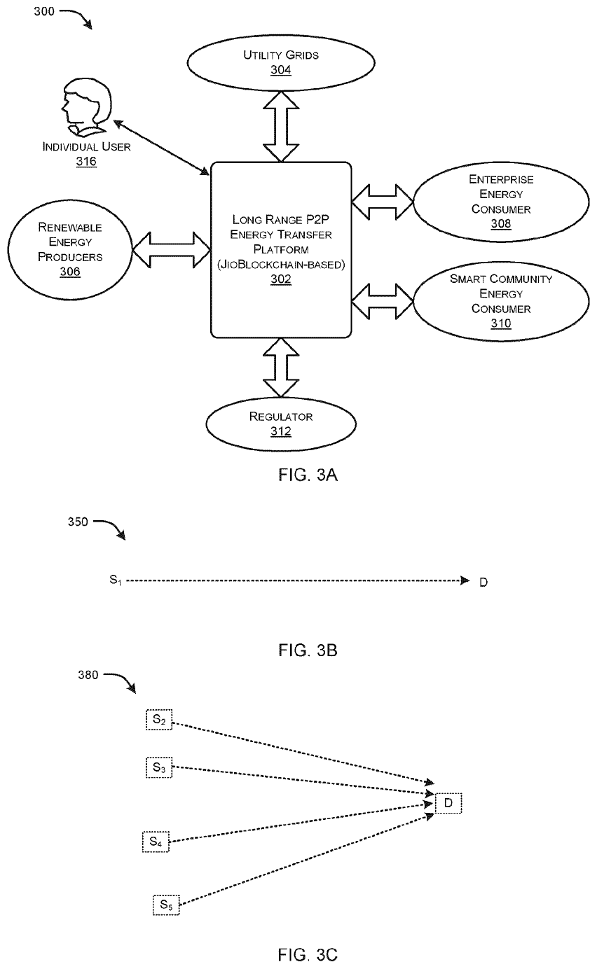

FIG. 3A illustrates exemplary flow diagram (300) representation of blockchain based platform/system (302) (also known as the blockchain based platform/system (110))for the long range peer to peer energy transfer, in accordance with an embodiment of the present disclosure. The participating entities (114) may include any or a combination of, but not limited to renewable energy producers (306), a source utility smart grid and a destination utility smart grid together known as a utility grids (304). The consumers (102) may include, but not limited to an enterprise energy consumer (308), a smart community energy consumer (310) and an individual user (316) as shown in FIG. 3A. The blockchain based platform/system (300) may facilitate the energy transfer through one or more utility grids (304). The regulator (312) may include services that may regulate the energy transfer from the entities (114) to the consumers (102). The regulator (312) may include service levels for tier wise consumption that can meet separate charge/billing rate and generate revenue to the various stakeholders. For example, the regulator may further include top tier premium consumers that require uninterrupted power supply. The billing rate for providing uninterrupted power supply may be prescribed by the regulator (312) and recorded accordingly.

Additionally, the regulator (312) may provide services to particular entities (114) during a natural disaster. For example, hospitals and food storage facilities may be prioritized and provided with the energy transfer with prescribed billing rates. Further, the regulator (312) may provide an intermittent energy transfer to stakeholders based on their tier wise categorization. The regulator (312) may also include a micro service that provides the energy transfer and a policy module to regulate the access to the blockchain based platform/system (302). The policy module may monitor the access to information about energy transfer between various stakeholders. Also, it may include a dashboard to be accessed by auditors/regulatory bodies that monitor various aspects from power generation to power consumption.

In an embodiment, the blockchain based platform/system (302) may record the one or more parameters such as the energy transfer cost, the energy transfer duration, and the total units of energy transfer associated with energy transfer from the one or more entities (114) to the one or more consumers (102).

FIG. 3B illustrates an exemplary schematic diagram representation (350) of energy transfer from a single source (S1) to a destination (D), in accordance with an embodiment of the present disclosure. It shows a single source SI communicating with a Destination D. Such an energy transfer could involve one more utility grids and entities providing transmission and distribution services for energy transfer. Energy losses can occur during the energy transfer, and may be accounted for.

The blockchain based platform/system (302) may further compute the energy loss based on the total units of energy transfer across the one or more windows and record the differential energy transfer from the one or more entities (114) to the one or more consumers (102). Also, the blockchain based platform/system (302) may enable the dynamic energy transfer based on the recorded differential energy transfer from the one or more entities (114) to the one or more consumers (102).

In an embodiment, the blockchain based platform/system (302) may compute the revenue accumulated by the one or more entities (114) based on the energy transfer from the one or more entities (114) to the one or more consumers (102). Further, the blockchain based platform/system (302) may use the one or more additional platforms to settle the revenue accumulated by the one or more entities (114) and the cost incurred by the one or more sources (102) based on the dynamic energy transfer.

For example, the energy transfer provided through the renewable source (or entities (114)) can vary with time, depending on weather conditions, solar energy/irradiance received by solar panels, solar panel efficiency, time of the day, wind speed, wind orientation, geographical location of a wind turbine, and wind turbine efficiency. Hence, the estimation of the energy loss may provide better estimates for energy loss factors which can be calculated from the specific end-to-end path as the source S1 to destination D.

In an embodiment, the blockchain based platform/system (302) may enable the dynamic energy transfer based on the recorded differential energy transfer from the one or more entities (114) to the one or more consumers (102). Further, for determining energy loss during the energy transfer, energy transmission and distribution losses need to be continuously monitored. Specifically, high-voltage, low-loss transmission lines are utilized for long-range energy transmission which can incur a loss of 2% of the energy transferred. Such transmission can be combined with lower-voltage, high-loss distribution lines that are used for distribution. These combined losses can further incur higher losses of the order of 4%, so that the overall energy loss on an end-to-end path of the order of 6% of the overall energy is transferred between a source and a destination. It should be noted that (1−0.02)*(1−0.04)=1−0.02−0.04+0.0008≈1−0.02−0.04=1−0.06 so that the effective combined energy loss is of the order of 6% if a transmission loss of 2% followed by a distribution loss of 6%.

In an embodiment, the blockchain based platform/system (302) may compute the revenue accumulated by the one or more entities (114) based on the energy transfer from the one or more entities (114) to the one or more consumers (102)

The blockchain based platform/system (302) may also use the one or more additional platforms to settle the revenue accumulated by the one or more entities (114) and the cost incurred by the one or more sources (102) based on the dynamic energy transfer.
Specifically, the cost κ(Ti) per kWh needs to account for such end-to-end energy losses to compensate the renewable energy producers (306), the enterprise energy consumer (308), the smart community energy consumer (310) and the individual user (316).

For example, if the overall loss for energy transfer from source S1 to a destination D is of the order of percentage q1, then the cost κ(Ti) can be amplified by a factor 1/(1−q1) to a new factor κ(Ti)/(1−q1) or the differential energy to account for the energy transfer of E(Ti) to the destination. Hence, the effective energy supplied by the source may be equivalent to E(Ti)/(1−q1). If the energy loss is incurred differentially along the end-to-end path for energy transfer, with the energy loss factor qj incurred with respect to each stakeholder (renewable energy producer (308), the enterprise energy consumer (308), smart community energy consumer (310), the individual user (316) j, and if energy ES1 is supplied at the source, then the net energy received/dynamic energy at the destination is given by E(Ti)=ES1 πj (1−q1, j). In an embodiment, the blockchain based platform/system (302) may provide dynamic energy transfer based on the aggregated differential energy transfer between the renewable energy producers (306) and the enterprise energy consumer (308), the smart community energy consumer (310) and the individual user (316).

Further, the πj (1−q1, j) represents a product factor based on losses to determine the residual energy remaining at the destination. If this results in an overall loss energy factor of q for the end-to-end energy transfer path, then ES1 (1−q1)=ES1 πj (1−q1, j), so that q1=1−πj (1−q1, j). In the blockchain based platform/system (302), if the end-to-end path is reused for energy transfer between the source and the destination, then the actual losses incurred can be measured, so that better estimates of the energy loss factor q1, j can be made for a specific end-to-end path from source S1 to destination D.

In an exemplary embodiment, for one or more time windows Tᵢ, the cost κ(Tᵢ) per kWh may dynamically vary across time window and the amount of transferred energy E(Tᵢ) in kWh is recorded. For example, the revenue accumulated may be partitioned in the ratio α₁:α₂ : . . . : αₖ across k stakeholders that assist in the physical transfer of energy or energy transfer, where Σⱼ αⱼ=1. The net revenue across multiple time windows Tᵢ can be aggregated, such that each stakeholder j earns revenue αⱼ Σᵢ κ(Tᵢ) E(Tᵢ).

In an exemplary embodiment, the cost per kWH may be based on the demand requested by the consumers (102) as described in FIG. 1. Additionally, the cost per kWh may depend on the energy available at the source and the amount of effective energy transfer by the entities (114) as described in FIG. 1. Hence, the cost per kWh may dynamically vary across time windows.

FIG. 3C illustrates an exemplary schematic diagram representation (380) of multi-source fault tolerant long range P2P energy transfer, in accordance with an embodiment of the present disclosure. FIG. 3C shows the usage of multiple renewable energy sources S1, S2, . . . Sk, . . . SM, supplying energy to a single destination D to provide fault tolerance and resilience while meeting the energy requirements at the destination D. In this case, if energy ESk is supplied by the renewable energy source Sk, then the net energy received at the destination is given by ESk πj (1−qk, j) where πj (1−qk, j) represents a product factor based on losses to determine the residual energy remaining at the destination. The overall energy received at the destination D is given by the sum of the energies received along the M as shown in equation 1 below.

E(Ti)=Σk ESk πj (1−qk, j) . . . Equation 1

In an embodiment, the blockchain based platform/system (302) may use the plurality of energy sources with any or a combination, but not limited solar energy and wind energy to provide a multi-path fault tolerant energy transfer. The multi-path fault tolerant energy transfer may be indicative of the dynamic energy transfer across the one or more time windows from the one or more entities (114) to the one or more consumers (102). The blockchain based platform/system (302) may further execute the smart contract between the entities (114) and the consumers (102) based on the multi-path fault tolerant energy transfer. The smart contract may be indicative of the dynamic energy transfer from the plurality of energy sources across the one or more time windows from the one or more entities (114) to the one or more consumers (102). Additionally, the blockchain based platform/system (302) records the revenue accumulated by the one or more entities (114) and the cost incurred by the one or more sources (102) based on the smart contract.

For example, the different renewable energy sources may belong to a single organization that supplies energy to the destination, so that the best available paths with minimal losses or path delays, or based on dynamic energy variability and availability at each energy source can be chosen to provide the required energy at the destination. The different renewable energy sources can inform the blockchain based platform/system (302) about the energy availability so that the best set of energy sources can be select to provide energy to the destination D at any given time. This information can be recorded on the blockchain based platform/system (302) with a smart contract that determines the energy sources selected to provide energy to destination D.

In an embodiment, the blockchain based platform/system (302) may compute the excess energy supply from the plurality of energy sources and record the excess energy supply. Further, the blockchain based platform/system (300) may enable the one or more consumers (102) to select from the plurality of energy sources to receive the dynamic energy transfer across the one or more time windows.

For example, storing energy at a source or destination may be possible if the renewable energy producers (306) (part of the entities (114)) produce more energy than is supplied by it at a given time. In such a case, excess energy could be stored in a battery at the energy source, or stored within a utility grid to be supplied at a later point in time (such as at night or in low light conditions) when the energy source may not produce adequate energy. Hydrogen can be utilized as an energy carrier as well by utilizing available excess renewable energy to be converted to Hydrogen, by splitting water into Hydrogen and Oxygen in an electrolyser. Similarly, it is possible that due to dynamic variability in the energy availability from different sources or variable energy losses along paths, excess energy can arrive at a destination in a short interval of time. Information about excess energy transfer or the relative supply of energy from different sources can be recorded in the blockchain ledger, and correspondingly, the revenue accumulated by the renewable energy producers(306) maybe computed.

In an exemplary embodiment, the blockchain based platform/system (302) may support multiple destinations. If different destinations have different priorities, then energy could be shared across different destinations based on energy availability and needs at each destination. The LORPET blockchain/virtualization for Distributed Ledger Technology (vDLT) platform(also known as the blockchain based platform/system (302)) can provide the smart contracts to enable such energy sharing across destinations based on energy availability from different renewable energy sources. Each destination can also choose to receive its energy requirements from alternate energy sources from the utility grid or transmission/distribution companies.

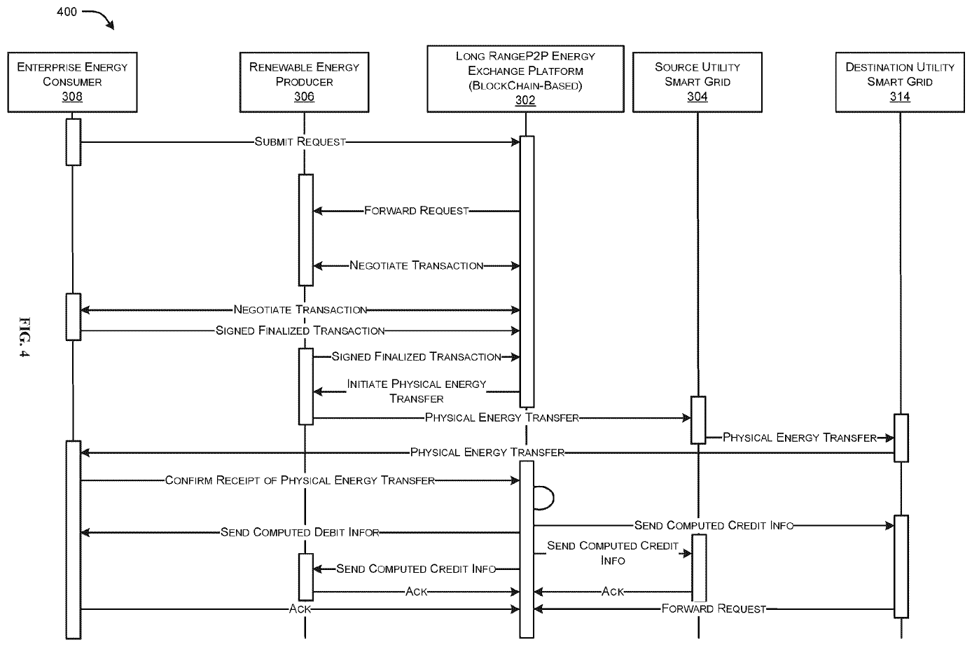

FIG. 4 illustrates a sequence diagram representation of the long-range peer to peer energy exchange platform (P2P) (400) (also referred as blockchain based platform/system (302)), in accordance with an embodiment of the present disclosure. In an embodiment, the long-range peer to peer energy exchange process involves information exchange using the digital signature between participating entities.

At step (402), the enterprise energy consumer (308)or the smart energy community consumer (310) may submit one or more requests to the renewable energy producer (306) for the energy transfer. The one or more requests may be indicative of the energy demand from the enterprise energy consumer (308), the smart energy community consumer (310) and the individual user (316).

At step (404), the long-range peer to peer energy exchange platform (302) may receive and forward the one or more requests to the renewable energy producer (306).

At step (406, 408), the long-range peer to peer energy exchange platform (302) may negotiate between the renewable energy producer (306) and the enterprise energy consumer (308). The negotiation may be indicative of the total units of energy transfer associated with the unit of energy across the one or more time windows.

At step (410, 412), the long-range peer to peer energy exchange platform (302) may form a digital contract between the renewable energy producer (306), the enterprise energy consumer (308), the smart community energy consumer (310) and the individual user (316). The digital contract may be indicative of the cost of the unit of energy associated with an energy transfer across one or more time windows. The long-range peer to peer energy exchange platform (302) may verify the digital contract and initiate the energy transfer.

At step (414, 416, 418, 420), the source utility smart grid (304) and the destination utility smart grid (314) may assist in the energy transfer. In addition, one or more intermediate energy grids may also be engaged in the energy transfer process on an end-to-end path between the source and the destination.

At step (422), the energy transfer may be completed along the end-to-end path for energy transfer based on the verified digital contract.

At step (424, 426, 428, 430), the total cost incurred by the enterprise energy consumer (308) is determined. Additionally, the revenue accumulated by the renewable energy producer (306) is also determined.

At step (432, 434, 436, 438) the total cost and the revenue accumulated may be recorded on the blockchain based platform/system (302).

The blockchain-based long range peer to peer energy transfer platform (LORPET) (302) (also known as blockchain based platform/system (302)) can thus be utilized to accomplish the digital recording of the process along with enabling the actual physical energy transfer. To summarize, LoRPET helps in negotiating a digital contract between the renewable energy producer (306) and the enterprise energy consumer (308). The blockchain based platform/system (302) may verify digital signatures and record the verified digital contract in the LoRPET blockchain ledger. The LoRPET may initiate the physical transfer of energy from the renewable energy producer (306) through utility grids to the enterprise energy consumer (308), where the receipt is confirmed by the enterprise energy consumer (308). The blockchain based platform/system (302) can execute a smart contract based on the agreed contract to determine cost incurred by the enterprise energy consumer (308) and the revenue accumulated by the renewable energy producer (306) and utility grids (source utility smart grid (304) and destination utility smart grid (314)) engaged in the energy transfer. The outcome of such processing is recorded in the LoRPET blockchain ledger. The LoRPET may share the computed debit and credits with participating stakeholders (such as the renewable energy producer (306) the enterprise energy consumer (308), and the utility grids). Payments and settlements can be achieved using the long range peer to peer energy transfer platform (LORPET) (302) or the one or more additional platforms. To determining revenue, for each time window Ti, the cost κ(Ti) per kWh (this can dynamically vary across time windows) and the amount of transferred energy E(Ti) in kWh may be recorded. Let the revenue be partitioned in the ratio α1:α2: . . . : αk across k stakeholders that assist in the physical transfer of energy where Σj ζj=1. The revenue across multiple time windows Ti can be aggregated, such that each stakeholder j earns revenue αj Σi κ(Ti) E(Ti). The net revenue may be settled on the one or more additional platforms (can be blockchain-based) for payments and settlements across the stakeholders.

Further, for determining Energy Loss during the energy transfer, energy transmission and distribution can incur losses in an end-to-end path for energy transfer. Specifically, high-voltage, low-loss transmission lines are utilized for long-range energy transmission which can incur a loss of 2% of the energy transferred. Such transmission can be combined with lower-voltage, high-loss distribution lines that are used for distribution, which can incur higher losses of the order of 4%, so that the overall energy loss on an end-to-end path can of the order of 6% of the overall energy that is transferred between a source and a destination. It should be noted that (1−0.02)*(1−0.04)=1−0.02−0.04+0.0008≈1−0.02−0.04=1−0.06 so that the effective combined energy loss is of the order of 6% if a transmission loss of 2% followed by a distribution loss of 6% is encountered in an end-to-end path for energy transfer. Specifically, the cost κ(Ti) per kWh needs to account for such end-to-end energy losses to compensate the source renewable energy producer, and participating grids and entities.

For example, if the overall loss for energy transfer from source S1 to a destination D is of the order of percentage q1, then the cost κ(Ti) can be amplified by a factor 1/(1−q1) to a new factor κ(Ti)/(1−q1) to account for the energy transfer of E(Ti) to the destination with effective energy supplied by the source equivalent to E(Ti)/(1−q1). If the energy loss is incurred differentially along the end-to-end path for energy transfer, with the energy loss factor qj incurred with respect to each stakeholder j, and if energy ES1 is supplied at the source, then the net energy received at the destination is given by E(Ti)=ES1 πj (1−q1, j) where πj (1−q1, j) represents a product factor based on losses to determine the residual energy remaining at the destination. If this results in an overall loss energy factor of q for the end-to-end energy transfer path, then ES1 (1−q1)=ES1 πj (1−q1, j), so that q1=1−πj (1−q1, j). In the system, if the end-to-end path is reused for energy transfer between the source and the destination, then the actual losses incurred can be measured, so that better estimates of the energy loss factor q1, j can be made for a specific end-to-end path from source S1 to destination D.

For, multi-path fault tolerant energy transfer, the renewable energy producer (306) can have variability in energy production over time based on factors such as the weather, processing efficiency of solar panels or wind turbines, solar irradiance, wind direction, wind turbine position, and the time-of-the-day. Since, solar panels produce energy during the day when there is sunlight, energy transfer could be accomplished using wind energy at alternate times, or by supplying stored energy from received energy at the solar panel, etc., so that such energy transfers can be accomplished at different times of the day based on the dynamic need for energy at the destination. For this purpose, one may choose to employ multiple renewable energy production sites to supply energy to a given consumer to ensure fault tolerance in the long-range end-to-end energy transfer. It is also possible that the energy supplied by a single renewable energy production site may not be enough to meet the energy E (Ti) required by a consumer. In that case as well, multiple renewable energy production sites could jointly supply energy to the consumer.

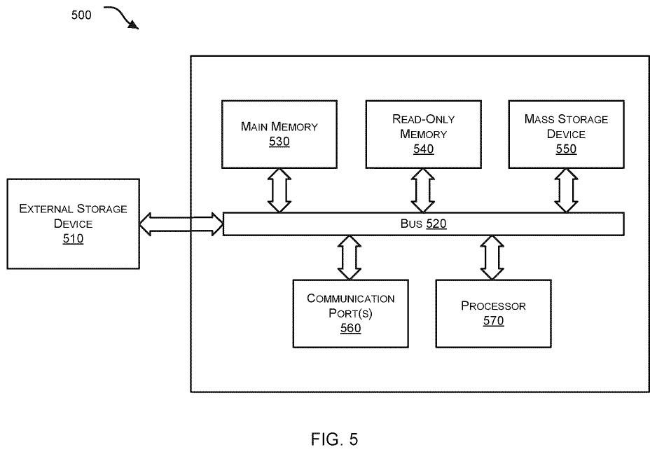

FIG. 5 illustrates an exemplary computer system (500) in accordance with embodiments of the present disclosure. As shown in FIG. 5, computer system (500) can include an external storage device (510), a bus (520), a main memory (530), a read only memory (540), a mass storage device (550), communication port (560), and a processor (570). A person skilled in the art will appreciate that the computer system may include more than one processor and communication ports. Processor (570) may include various modules associated with embodiments of the present invention. Communication port (560) can be any of an RS-232 port for use with a modem-based dialup connection, a 10/100 Ethernet port, a Gigabit or 10 Gigabit port using copper or fiber, a serial port, a parallel port, or other existing or future ports. Communication port (560) may be chosen depending on a network, such a Local Area Network (LAN), Wide Area Network (WAN), or any network to which computer system connects. Memory (530) can be Random Access Memory (RAM), or any other dynamic storage device commonly known in the art. Read-only memory (540) can be any static storage device(s) e.g., but not limited to, a Programmable Read Only Memory (PROM) chips for storing static information e.g., start-up or BIOS instructions for processor (570). Mass storage (550) may be any current or future mass storage solution, which can be used to store information and/or instructions.

Bus (520) communicatively couples processor(s) (570) with the other memory, storage and communication blocks. Bus (520) can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor (570) to software system.

Optionally, operator and administrative interfaces, e.g., a display, keyboard, and a cursor control device, may also be coupled to bus (520) to support direct operator interaction with a computer system. Other operator and administrative interfaces can be provided through network connections connected through communication port (560). In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### ADVANTAGES OF THE PRESENT DISCLOSURE

The present disclosure provides methods and systems for transferring long range peer-peer (P2P) energy.

The present disclosure provides a system and a method to facilitate the long range P2P energy transfer.

The present disclosure provides a blockchain based platform/system to enable the distribution of energy from the entities to the consumers.

The present disclosure provides a block chain based platform/system that enables negotiation between the entities and the consumers.

The present disclosure provides a blockchain based platform that executes a smart contract to determine the cost incurred by the consumers and revenue accumulated by the entities.

The present disclosure provides a block chain based platform that enables multiple energy sources to supply energy to the consumers to ensure fault tolerance in the long range peer to peer energy transfer.

We claim:

1. A system (110) for blockchain based platform with long range peer to peer energy transfer, said system comprising:
a blockchain network (112) comprising a plurality of nodes communicatively coupled to each other and wherein each of the nodes is configured with one or more processors (202), the one or more processors (202) coupled with a memory (204), wherein said memory (204) stores instructions which when executed by the one or more processors (202) causes the processor (202) to:
receive, one or more requests from one or more first computing devices (104) indicative of an energy demand, wherein the one or more first computing devices (104) are associated with one or more consumers (102) and communicatively coupled to the blockchain network (112) through a communication network (106);
receive, one or more inputs from one or more second computing devices (108) indicative of an energy supply, wherein the one or more second computing devices (108) are associated with one or more entities (114) and communicatively coupled to the blockchain network (112) through the communication network (106);
extract a first set of attributes from the one or more requests indicative of the energy demand from the one or more consumers (102);
extract a second set of attributes based on the first set of attributes from the one or more inputs, the second set of attributes indicative of the energy supply from the one or more entities (114);
based on the first set of attributes, and the second set of attributes, execute a digital contract between the one or more entities (114) and the one or more consumers (102), wherein the digital contract is indicative of the cost of a unit of energy associated with an energy transfer across one or more time windows from the one or more entities (114) to the one or more consumers (102); and
based on the digital contract, initiate, the energy transfer from the one or more entities (114) to the one or more consumers (102).

2. The system as claimed in claim 1, wherein the system is further configured to: record a negotiation between the one or more entities (114) and the one or more consumers (102) based on the digital contract, wherein the negotiation is indicative of a total units of energy transfer associated with the unit of energy across the one or more time windows.

3. The system as claimed in claim 2, wherein the system is further configured: with a ledger to record the digital contract and the negotiation between the one or more entities (114) and the one or more consumers (102).

4. The system as claimed in claim 3, wherein the system is further configured to: verify the digital contract, using one or more digital signatures from the one or more entities (114) and the one or more consumers (102), and initiate the energy transfer.

5. The system as claimed in claim 4, wherein the system is further configured to: record the negotiation, and the verified digital contract in a ledger.

6. The system as claimed in claim 1, wherein the system is configured to: include any or a combination, but not limited to an enterprise energy consumer and a smart community energy consumer as the one or more consumers (102).

7. The system as claimed in claim 1, wherein the system is configured to: include any or a combination, but not limited to a renewable energy producer, a source utility smart grid and a destination utility smart grid as the one or more entities (114).

8. The system as claimed in claim 1, wherein the system is further configured to: record one or more parameters such as an energy transfer cost, an energy transfer duration, and the total units of energy transfer associated with energy transfer from the one or more entities (114) to the one or more consumers (102).

9. The system as claimed in claim 2, wherein the system is further configured to: compute an energy loss based on the total units of energy transfer across the one or more time windows and record the differential energy based on the energy loss and transfer from the one or more entities (114) to the one or more consumers (102).

10. The system as claimed in claim 9, wherein the system is further configured to: enable a dynamic energy transfer based on the recorded differential energy transfer from the one or more entities (114) to the one or more consumers (102).

11. The system as claimed in claim 10, wherein the system is further configured to: compute the revenue accumulated by the one or more entities (114) based on the energy transfer from the one or more entities (114) to the one or more consumers (102).

12. The system as claimed in claim 1, wherein the system is further configured to: use one or more additional platforms to settle the revenue accumulated by the one or more entities (114) and the cost incurred by the one or more sources (102) based on the total units of energy transfer during the dynamic energy transfer.

13. The system as claimed in claim 1, wherein the system is configured to: use a plurality of energy sources with any or a combination, but not limited solar energy and wind energy to provide a multi-path fault tolerant energy transfer, wherein the multi-path fault tolerant energy transfer is indicative of the dynamic energy transfer across the one or more time windows from the one or more entities (114) to the one or more consumers (102).

14. The system as claimed in claim 13, wherein the system is configured to: compute a smart contract based on the multi-path fault tolerant energy transfer, wherein the smart contract is indicative of the dynamic energy transfer from the plurality of energy sources across the one or more time windows from the one or more entities (114) to the one or more consumers (102).

15. The system as claimed in claim 14, wherein the system is further configured to: record the revenue accumulated by the one or more entities (114) and the cost incurred by the one or more sources (102) based on the smart contract.

16. The system as claimed in claim 14, wherein the system is further configured to: compute an excess energy supply from the plurality of energy sources and record the excess energy supply in the ledger; and enable the one or more consumers (102) to select from the plurality of energy sources to receive the dynamic energy transfer across the one or more time windows.

17. A method (600) for a blockchain based platform with long range P2P energy transfer, said method comprising:
a blockchain network (112) comprising a plurality of nodes communicatively coupled to each other and wherein each of the nodes are configured with one or more processors (202), the one or more processors (202) coupled with a memory (204), wherein said memory (204) stores instructions and executed by the one or more processors (202);
receiving, by the processor (202), one or more requests from one or more first computing devices (104) indicative of an energy demand, wherein the one or more first computing devices (104) are associated with one or more consumers (102) and are communicatively coupled to the blockchain network (112) through a communication network (106);
receiving, by the processor (202), one or more inputs from one or more second computing devices (108) indicative of an energy supply, wherein the one or more second computing devices (108) are associated with one or more entities (114) and communicatively coupled to the blockchain network (112) through the communication network (106);
extracting, by the processor (202), a first set of attributes from the one or more requests indicative of the energy demand from the one or more consumers (102);
extracting, by the processor (202), a second set of attributes based on the first set of attributes, the second set of attributes indicative of the energy supply from the one or more entities (114);
forming, by the processor (202), based on the first set of attributes, and the second set of attributes, a digital contract between the one or more entities (114) and the one or more consumers (102), wherein the digital contract is indicative of a cost of a unit of an energy transfer across one or more time windows from the one or more entities (114) to the one or more consumers (102); and
initiating, by the processor (202), based on the digital contract, the energy transfer from the one or more entities (114) to the one or more consumers (102).

18. The method as claimed in claim 17, wherein the method further comprises: recording, by the processor (202), a negotiation between the one or more entities (114) and the one or more consumers (102) based on the digital contract, wherein the negotiation is indicative of the total units of energy transfer associated with a unit of energy transfer across the one or more time windows.

19. The method as claimed in claim 17, wherein the method further comprises: verifying, by the processor (202), the digital contract, using one or more digital signatures from the one or more entities (114) and the one or more consumers (102) and initiating the energy transfer.

20. The method as claimed in claim 18, wherein the method comprises: recording by the processor (202), the negotiation, and the verified digital contract in a ledger.

21. A user equipment (UE) (114) for a blockchain based platform with long range peer to peer energy transfer, said UE comprising:
one or more processors (220), the one or more processors (220) coupled with a memory (222), wherein said memory (222) stores instructions which when executed by the one or more processors (220) causes said user equipment (UE) (114) to:
receive one or more requests from one or more first computing devices (104) indicative of an energy demand;
transmit the one or more requests from the one or more first computing devices (104) to the system (110), wherein the user equipment (UE) (114) is communicatively coupled to a blockchain network (112) through a communication network (106);
wherein the system (110) comprises a plurality of nodes communicatively coupled to each other in the blockchain network (112) and wherein each of the nodes is configured with one or more processors (202), the one or more processors (202) coupled with a memory (204), wherein said memory (204) stores instructions which when executed by the one or more processors (202) causes the processor (202) to:
receive one or more requests from one or more first computing devices (104) indicative of an energy demand, wherein the one or more first computing devices (104) are associated with one or more consumers (102) and are communicatively coupled to the blockchain network (112) through the communication network (106);
receive, one or more inputs from one or more second computing devices (108) indicative of an energy supply, wherein the one or more second computing devices (108) are associated with one or more entities (114) and communicatively coupled to the blockchain network (112 through the communication network;
extract a first set of attributes from the one or more requests indicative of the energy demand from the one or more consumers (102);
extract a second set of attributes from the one or more inputs based on the first set of attributes, the second set of attributes indicative of the energy supply from the one or more entities (114);
based on the first set of attributes, and the second set of attributes, form a digital contract between the one or more entities (114) and the one or more consumers (102), wherein the digital contract is indicative of a cost of a unit of an energy transfer across one or more time windows from the one or more entities (114) to the one or more consumers (102); and
based on the digital contract, initiate, the energy transfer from the one or more entities (114) to the one or more consumers (102).
